(19) United States
(12) Patent Application Publication
(10) Pub. No.: US 2006/0036738 A1
(43) Pub. Date: Feb. 16, 2006

(54) Broadband extension to an EPABX or PABX

(75) Inventor: Ajit G. Hemmady, Phoenix, AZ (US)

Correspondence Address: AJIT G. HEMMADY, 4717 E. MOSSMAV RD, PHOENIX, AZ, 85050, US

(73) Assignee: Ajit G. Hemmady, Phoenix, AZ (US)

(21) Appl. No.: 10/710,954

(22) Filed: Aug. 13, 2004

(51) Int. Cl. G06F 15/16

(52) U.S. Cl. 709/227

(57) ABSTRACT

The patent defines and describes system architecture, methods and claims that allow broadband (several hundred kbps to several mbps) services access to end users and end user equipment to existing PABX or EPABX. The architecture is two major manifestations: as an external or remote box or node attached via some physical communication link to the existing PABX or via integrating such a capability within the existing PABX. There can be several sub-manifestations of these two major manifestations or architecture types and the patent with its associated claims covers all of such manifestations. It must be clearly stated that the patent is not trying to patent any of the technologies that are used within this patented architecture but it is merely patenting the architecture that allows the use of the existing technologies to achieve the goal stated in this patent.

The invention relates to the method, architecture and interfaces that allow extensions to existing PABX or EPABX such that it will allow broadband (from several hundred kbps to several mbps) service connections to the end users of the PABX or EPABX.
Patent Citation 1: U.S. Pat. No. 5,805,692 Private automatic branch exchange (PABX) system with transparent computer supported telecommunications applications (CSTA) functionality, Oerlemans et al.
Patent Citation 2: U.S. Pat. No. 5,896,377 Broadband or narrowband interworking, Boot et al.
Patent Citation 3: U.S. Pat. No. 6,324,410 Method and apparatus for interfacing a cellular fixed wireless terminal to the extension side of a PBX or PABX, Giacopelli et al.
Patent Citation 4: U.S. Pat. No. 6,363,079 Multifunction interface facility connecting wideband multiple access subscriber loops with various networks, Barzegar et al.
Patent Citation 5: U.S. Pat. No. 6,366,656 Method and apparatus for migrating embedded PBX system to personal computer, Lee et al.
Patent Citation 6: U.S. Pat. No. 6,430,395 Wireless private branch exchange (WPBX) and communicating between mobile units and base stations, Arazi et al.
Patent Citation 7: U.S. Pat. No. 6,522,663 Telecommunications network architecture for transporting fax, voice and data via an ATM switch including a STM to ATM terminal adapter, Bharucha et al.
Patent Citation 8: U.S. Pat. No. 6,477,245 Method for the management of a telephone automatic branch exchange, external management device and corresponding automatic branch exchange, Chevet et al.
Patent Citation 9: U.S. Pat. No. 6,452,925 Universal access multimedia data network, Sistanizadeh et al.

### DEFINITION LIST 1

Term: ADSL
   Definition: Asymmetric Digital Subscriber Loop
Term: aka
   Definition: Also known as
Term: ATM
   Definition: Asynchronous Transfer Mode
Term: DS1
   Definition: Digital Signal 1 mode
Term: DS3
   Definition: Digital Signal 3 mode
Term: DSL
   Definition: Digital Subscriber Loop
Term: DSP
   Definition: Digital Subscriber Loop
Term: DTC
   Definition: Desk Top Computer
Term: EPABX
   Definition: Electronic Private Automatic Branch Exchange
Term: Gbps, gbps
   Definition: Giga Bits Per Second
Term: IP
   Definition: Internet Protocol
Term: IPI
   Definition: Internet Protocol Interface
Term: ISDN
   Definition: Integrated Services Digital Network
Term: Kbps, kbps
   Definition: Kilo Bits Per Second
Term: Mbps, mbps
   Definition: Mega Bits Per Second
Term: OC3
   Definition: Optical Carrier Type 3
Term: OC12
   Definition: Optical Carrier Type 12
Term: OC48
   Definition: Optical Carrier Type 48
Term: PABX
   Definition: Private Automatic Branch Exchange
Term: PC
   Definition: Personal Computer
Term: PCM
   Definition: Pulse Code Modulation
Term: PVC
   Definition: Permanent Virtual Circuit
Term: SDSL
   Definition: Symmetric Digital Subscriber Loop
Term: SVC
   Definition: Switched Virtual Circuit
Term: VDSL
   Definition: Very (high-speed) DSL
Term: VOIP
   Definition: Voice Over IP
Term: VOATM
   Definition: Voice Over ATM
Term: XDSL
   Definition: Some form of DSL

The present invention outlines a method and a system architecture that will allow broadband (several hundred kbps to several mbps) end user connections to an existing PABX or EPABX.

This patent describes the technology, architecture, methodology, high level hardware and software capabilities that will provide high bandwidth (broadband) end user connectivity to a PABX or EPABX. The current technology, architecture and the art in today's PABX or EPABX does not provide the end users more than 144 kbps connectivity that is provided via ISDN. The technology that is described in the patent will provide end users network connectivity that will be in excess of 2 mbps and thus allow high bandwidth services to these users. The services that they can avail themselves via this patented technology will be high speed data, image and video services, which today they have to access via alternate and expensive networks. Although the patent uses components that are currently available in the public domain, the patent is being applied for the innovative, inexpensive architecture involving these technologies and components that so far have not been invented or used. There are several manifestations which can be devised to duplicate or implement the basic ideas and architectures described in this patent. As such, this patent will encompass claims that will prohibit such manifestations and implementations. It is the goal of this patent to cover all aspects of high speed broadband services and specific technology implementations that are described in this patent. It does not attempt to patent architectures and services related to Voice over Internet Protocol (VOIP) or Voice over ATM (VOATM) capability that is currently in use and may or may not have been patented. This patent will describe the architecture and technology via several diagrams as well as detailed descriptions of the interfaces that are being used innovatively in the architectures being patented and that have not been in the public domain to the best of knowledge of the inventor.

### DESCRIPTION OF DRAWINGS

FIG. 1 shows the main aspect of the patent which is the architecture of the system. Various items within the figure have been labeled numerically for reference purpose. [50] Is the existing PABX or EPABX. It contains all the hardware and software that is necessary to provide today's narrowband voice and data services. [40] Is the extension box or node to the PABX [50] that contains the hardware and software that will provide broadband services to the end users, which can be a Personal Computer (PC) or Desk Top Computer (DTC) or Integrated Digital Access Device [10], a Digital or Video or IP Phone [20] or an Integrated PC or DTC or Phone [30]. It is possible to connect other broadband high-speed access devices via [40]. The extension box or node [40] is connected to the PABX via some physical link connection that can be of a metallic copper type (coaxial of various types, twisted pair) [70] or can be optical [60]. Access devices [10], [20] or [30] are connected to the extension box [40] via some form of metallic copper type physical link [70] as described above. The end users communicate broadband information among themselves or within the telecommunication or data communication network via the hardware and software provided within this architecture.

FIG. 2 shows the various interfaces or hardware implemented within the extension box or node (FIG. 1, [40]) of the new architecture. As described in the patent these can be of the type xDSL [80] of the type ADSL, VDSL, SDSL etc.; IP Interface (IPI) [90] that can be 10 mbps, 100 mbps or 1 gbps Ethernet or any higher speeds; Digital Interfaces (DS1 or DS3, ATM DS1 or DS3 [100] and Optical Interfaces (OC3 or OC12 or OC48 or higher speeds) shown as [110]. The end user devices shown (in FIG. 1, [10], [20] or [30]) can be connected to the extension box (FIG. 1, [40]) via some of these interfaces [80], [90] or [100]. The extension box itself can be connected to the PABX (FIG. 1, [50]) via interface type [100] or [110].

FIG. 3 shows the variation of the architecture being patented in which the broadband interfaces shown in FIG. 2 are integrated within the PABX [50] rather than located in a separate (remote) extension box or node. In this architecture the broadband interfaces xDSL [80], IPI [90], Digital Interfaces of the type DS1 or DS3 or ATM DS1 or DS3 and others [100] and Optical Interfaces OC3 or OC12 or OC48 and others [110] are located or integrated within the PABX [50]. In either of the architectures there is no difference in the broadband services provided to the end users. The implementation of the architecture (in terms of hardware or software) may have minor variations to accommodate these architectural variations. [120] Shows the interface link between the PABX and the rest of the telecommunications or data communications network.

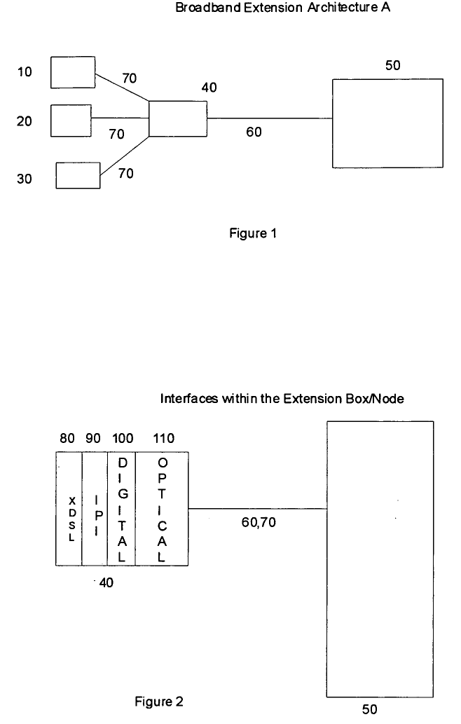

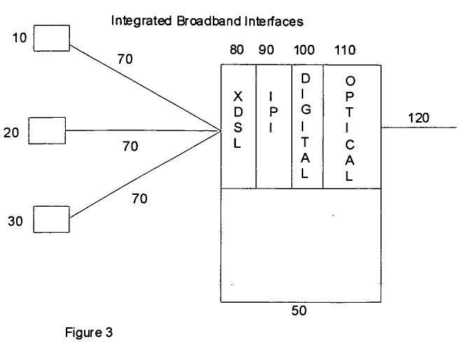

Both architectures are claimed as hitherto not invented in the realm of a PABX or EPABX system and as such claimed as a new invention.

### BACKGROUND ART

PABX (Private Automatic Branch Exchange) or EPABX (Electronic Automatic Branch Exchange) have been in existence for several years. They have provided voice and low speed data services to a cluster of end users, typically in a business environment. They are referred to as a branch exchange because they provide similar services as a Central Exchange or a Central Office (aka Class 5 Exchange or Office within the hierarchy of North American telecommunications network) but are much smaller in size and most of the times provide a subset of services (hence the terminology “branch”) that the larger system provides.

On the other hand PABXs provide certain unique voice and data services that are not typically provided within the larger Central Exchanges. There is a manifestation within a Central Exchange that mimics PABX services and is generally known as a Central Exchange with Centrex services.

Over the years the PABXs have evolved and have added new communication protocols, hardware and software technologies. These added capabilities, which are typically based on addition of computer technology and new electronics as well as software, have resulted in the elevation of the PABX (which originally started as electromechanical systems) to the new terminology of EPABX or Electronic PABX.

It will take several pages to describe the previous art of PABX and EPABXs. As such this patent cites certain public domain documents, books and patents that describe the art and anyone interested in the art can refer to these references.

The current art within the realm of PABX or EPABXs has been able to provide a plethora of voice (which is considered as a low speed information transmission) services and low speed data transmission services. With the advent of ISDN (Integrated Services Digital Network) technology a few years ago and its implementation within these systems, the data communication services within a PABX or EPABX have achieved a speed or bandwidth of 144 kbps. These services are generally referred to as narrow band data services.

No inventor or a business entity has made an attempt to come up with architecture for these PABXs or EPABXs that provides high speed (broadband) data, image and video services. These services generally start at several hundred kilobits per second (Kbps) and include services that utilize several megabits per second (Mbps).

Although several manifestations of a PABX or EPABX exist in which some form of adjunct or extension or application processor box is used, these applications are generally used to provide new features and services to the end users and businesses. There has yet been no implementation, manifestation or application that provides high bandwidth connectivity from an end user to the PABX or EPABX.

1. This invention claims an architecture extension to an existing PABX or EPABX architecture such that it will provide broadband services to the end user of such a PABX or EPABX.

2. It is claimed that there can be several logical manifestations of the architecture [c1] that is being patented in this application. These manifestations will result in providing broadband services to the end users of PABX or EPABX. As such all such manifestations are covered by this patent.

3. The architecture [c1] , the concept and the technology being patented here can also be implemented via several physical manifestations that can result in providing broadband services to the end users of PABX or EPABX. This patent covers al such manifestations.

4. The architecture extension to the existing PABX or EPABX can be physically located within the PABX or may be remotely located from the PABX and connected via some physical link that provides for transmission of broadband data and control signals from the extension to the PABX.

5. It is claimed that there can be several implementations of such an extension [c4]. However, all these implementations will result in provision of broadband end user connections that allow these users to transmit broadband data, images and video to other users connected to the PABX or other users connected to the telecommunication or data communication network.

6. It is claimed that the architecture [c1][c4] will provide broadband connectivity via Internet Protocol (IP) or some form of Digital Subscriber Loop (DSL) technology. The intent of the patent is not to patent the IP or any form of DSL technology since these technologies have been in the public domain for several years. The intent is to patent the architecture of a system that uses these technologies to provide broadband services to the end users.

7. It is claimed that the above described architecture [c1][c4] can be implemented via several (from 1 to N, where N can be a fairly large number) IP or some form of DSL interfaces.

8. The extension [c4] will generally be provided by some remote or external box or system that will house such IP or some form of DSL interfaces.

9. It is claimed that there can be some implementations wherein these IP or some form of DSL interfaces are located within the main PABX or EPABX [c4].

10. It is claimed that there are several forms of xDSL interface implementations such as ADSL, VDSL, SDSL, etc. and all variations are covered in this claim by using the terminology xDSL. Similarly there can be several types of IP interfaces (generally identified via speed or bandwidth of these interfaces). All such variations are covered by this claim.

11. It is claimed that the connectivity from the extension system to the main PABX or EPABX can be achieved via several methods using some form of a communication link. Although such means have been used in the past in the context of Central Office switches or other applications of PABX (e.g. U.S. Pat. No. 5,805,692 cited above), none have been invented to provide broadband services as described in this patent. Each of these methods is covered by this claim.

12. When the IP or any from of DSL interfaces are located within the PABX, the data and control signal transmissions from the end user apparatus to other end user apparatus or other users in the network is achieved via internal (back-plane bus) high speed connectivity. This is a requirement of an integrated solution described in [c4]

13. It is claimed that there are several manifestations or implementations of the connectivity of the implementations described in [c12]. These generally are various physical implementations that provide different bandwidth and or control signal speeds. This claim covers all such manifestations.

14. It is claimed that the connectivity [c11] from the extension box or system that houses IP or some form of DSL end user connectivity can be via a well known telecommunications or data communications link technology such as DS1, DS3, Optical Interface (such as OC3, OC12, OC48), Asynchronous Transmission Mode (ATM), some form of IP (10 mbps, 100 mbps or 1000 mbps or 1 gbps) interface. Again, it is not the intention of this patent to claim any uniqueness or invention as it pertains to these technologies. The intent is to patent the architecture of the system that uses these well known technologies to provide hitherto unknown services to the end users of PABXs.

15. It is claimed that several manifestations of the extension box [c1] can exist.
Some of these boxes may so called “smart” or “intelligent” boxes that contain call processing, signaling or some from of control function or intelligence capability. This intelligence may be provided via software or any other means such as use of Digital Signal Processor (DSP). Some implementations of this box can be “simple or dumb” and provide minimal control functionality. This patent claims uniqueness in the concept and the architecture for providing broadband services via these extensions rather than the technology that may or may not be used in these boxes or may be integrated within the PABX or EPABX.

16. The claim also extends to the instance [c4] where the means to provide the broadband service to the end user via an IP or some from of DSL technology interface is housed or located (IE integrated) within a PABX or EPABX. Most of this architectural uniqueness is further described in the drawings and accompanying text.

17. The information transfer between end users as well as the extension box or node and the PABX or in integrated PABX solution can take place via a Switched Virtual Circuit connection (SVC) or a Permanent Virtual Circuit connection (PVC).

18. The information transfer between end users as well as the extension box or node and the PABX takes place via some form of Packet Switch mode within the realm of the connections [c17] described above. In this mode, large amounts of information are transferred between end users via packets.

19. When end user connections are voice based rather than data or image or video transfer based, the implementation provides for appropriate conversion of the packet data to digital voice (Pulse Code Modulation—PCM) or analog signals that are required to allow voice based communication.

20. The implementation provides for appropriate conversion of packet data into image or video signals when such conversions are required.
